(19) United States
(12) Patent Application Publication
(10) Pub. No.: US 2024/0126580 A1
(43) Pub. Date: Apr. 18, 2024

(54) TRANSPARENTLY PROVIDING VIRTUALIZATION FEATURES TO UNENLIGHTENED GUEST OPERATING SYSTEMS

(71) Applicant: Microsoft Technology Licensing, LLC, Redmond, WA (US)

(72) Inventors: Jin LIN, Seattle, WA (US); David Alan HEPKIN, Redmond, WA (US); Michael Bishop EBERSOL, Woodinville, WA (US); Matthew David KURJANOWICZ, Wenatchee, WA (US); Aditya BHANDARI, Seattle, WA (US); Attilio MAINETTI, Bellevue, WA (US); Amy Anthony PARISH, Seattle, WA (US)

(21) Appl. No.: 18/145,247

(22) Filed: Dec. 22, 2022

Related U.S. Application Data
(60) Provisional application No. 63/416,283, filed on Oct. 14, 2022.

(51) Int. Cl. G06F 9/455

(52) U.S. Cl. CPC G06F 9/45545; G06F 9/45558; G06F 2009/45583; G06F 2009/45587

(57) ABSTRACT

Transparently providing a virtualization feature to an unenlightened guest operating system (OS). A guest partition, corresponding to a virtual machine, is divided into a first guest privilege context and a second guest privilege context. A compatibility component executes within the first guest privilege context, while a guest OS executes within the second guest privilege context. The compatibility component is configured to intercept input/output (I/O) operations associated with the guest operating OS. Based on the compatibility component intercepting an I/O operation associated with the guest OS, the compatibility component processes the I/O operation using a virtualization feature that is unsupported by the guest OS. Examples of the virtualization feature include accelerated access to a hardware device and virtual machine guest confidentiality.

### CROSS-REFERENCE TO RELATED APPLICATIONS

This application claims priority to, and the benefit of, U.S. Provisional Application Ser. No. 63/416,283, filed Oct. 14, 2022, and entitled “TRANSPARENTLY PROVIDING VIRTUALIZATION FEATURES TO UNENLIGHTENED GUEST OPERATING SYSTEMS,” the entire contents of which are incorporated by reference herein in their entirety.

### BACKGROUND

Hypervisor-based virtualization technologies allocate portions of a computer system's physical resources (e.g., processor cores and/or time, physical memory regions, storage resources) into separate partitions, and execute software within each of those partitions. Hypervisor-based virtualization technologies therefore facilitate creation of virtual machine (VM) guests that each executes guest software, such as an operating system (OS) and other software executing therein. While hypervisor-based virtualization technologies can take a variety forms, many use an architecture comprising a hypervisor that has direct access to hardware and that operates in a separate execution environment from all other software in the system, a host partition that executes a host OS and host virtualization stack, and one or more guest partitions corresponding to VM guests. The host virtualization stack within the host partition manages guest partitions, and thus the hypervisor grants the host partition a greater level of access to the hypervisor, and to hardware resources, than it does to guest partitions.

Taking HYPER-V from MICROSOFT CORPORATION as one example, the HYPER-V hypervisor is the lowest layer of a HYPER-V stack. The HYPER-V hypervisor provides basic functionality for dispatching and executing virtual processors for VM guests. The HYPER-V hypervisor takes ownership of hardware virtualization capabilities (e.g., second-level address translation (SLAT) processor extensions such as Rapid Virtualization Indexing from ADVANCED MICRO DEVICES, or Extended Page Table from INTEL; an input/output (I/O) memory management unit (IOMMU) that connects a direct memory access-capable I/O bus to main memory; processor virtualization controls). The HYPER-V hypervisor also provides interface(s) to allow a HYPER-V host stack within a host partition to leverage these virtualization capabilities to manage VM guests. The HYPER-V host stack provides general functionality for VM guest virtualization (e.g., memory management, VM guest lifecycle management, device virtualization).

The subject matter claimed herein is not limited to embodiments that solve any disadvantages or that operate only in environments such as those described above. Rather, this background is only provided to illustrate one example technology area where some embodiments described herein may be practiced.

### BRIEF SUMMARY

In some aspects, the techniques described herein relate to a method, including: intercepting, by a compatibility component within a first guest privilege context of a guest partition, an input/output (I/O) operation associated with a guest operating system (OS) that operates within a second guest privilege context of the guest partition; and processing, by the compatibility component, the I/O operation using a virtualization feature that is unsupported by the guest OS.

In some aspects, the techniques described herein relate to a computer system, including: a processing system; and a computer storage media that stores computer-executable instructions that are executable by the processing system to at least: intercept, by a compatibility component within a first guest privilege context of a guest partition, an I/O operation associated with a guest OS that operates within a second guest privilege context of the guest partition; and process, by the compatibility component, the I/O operation using a virtualization feature that is unsupported by the guest OS.

In some aspects, the techniques described herein relate to a computer program product including a computer storage media that stores computer-executable instructions that are executable by a processing system to at least: intercept, by a compatibility component within a first guest privilege context of a guest partition, an I/O operation associated with a guest OS that operates within a second guest privilege context of the guest partition; and process, by the compatibility component, the I/O operation using a virtualization feature that is unsupported by the guest OS.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates an example computer architecture that facilitates transparently providing virtualization features to an unenlightened guest OS;

FIG. 2A illustrates an example of virtual machine bus connections within the computer architecture of FIG. 1;

FIG. 2B illustrates an example of an enlightened guest OS utilizing a virtualization feature provided by a host virtualization stack;

FIG. 2C illustrates a first example of a compatibility component transparently providing a virtualization feature to an unenlightened guest OS;

FIG. 2D illustrates a second example of a compatibility component transparently providing a virtualization feature to an unenlightened guest OS; and

FIG. 3 illustrates a flow chart of an example method for transparently providing virtualization features to an unenlightened guest OS.

### DETAILED DESCRIPTION

As hypervisor-based virtualization technologies advance, they introduce new features that are visible to guest OSs, and which improve guest OS performance, security, etc. As examples, recent hypervisor-based virtualization technologies have improved guest OS performance with accelerated access to hardware (e.g., storage, networking), have expanded the range of hardware available to guest OS's by providing access to new hardware device types (e.g., new storage controller types), and have improved guest OS security with VM guest confidentiality that isolates VM guest memory and CPU state from a host OS (or even from the hypervisor itself). As these features are guest OS-visible, they presently require a VM guest to operate an “enlightened” guest OS in order to take advantage of these features. In the description herein, an “enlightened” guest OS refers to a guest OS that recognizes and supports specific feature(s) offered by a hypervisor-based virtualization technology (e.g., offered by a hypervisor and/or a related virtualization stack operating in a host partition). A guest OS may be enlightened by an OS vendor (e.g., via modifications to the guest OS's kernel and/or a bundled kernel module/driver) or by a third party (e.g., by providing a third-party kernel module/driver). Conversely, in the description herein, an “unenlightened” guest OS refers to a guest OS that lacks support for these specific feature(s).

Because a guest OS needs to be enlightened in order to support some virtualization features provided by hypervisor-based virtualization technologies, many VM guests may be unable to take advantage of those virtualization features when they become available. For example, due to a lack of appropriate guest OS enlightenments, the existing VM guests running at a given VM host may be unable to take advantage of new hardware-based virtualization features (e.g., accelerated hardware access, new hardware device types) when the VM host's hardware is upgraded, or the existing VM guests running at a given VM host may be unable to take advantage of new software-based virtualization features (e.g., VM guest confidentiality) when the hypervisor stack is upgraded at the VM host. While it is possible that these existing VM guests may be able to obtain these enlightenments via guest OS updates, those updates can be time-consuming to install, can be time-consuming to test, can be disruptive to VM guest workloads (e.g., due to guest OS restarts), and can potentially lead to failures or faults (e.g., upgrade failures, incompatibilities). Additionally, it is possible that the needed enlightenments are simply unavailable for a given guest OS, or cannot be used (e.g., due to regulatory or contractual constraints, due to software compatibility considerations), and thus a VM guest that operates this guest OS cannot take advantage of these new virtualization features.

The embodiments herein provide an architecture that transparently provides an unenlightened guest OS access to virtualization features that would normally require guest OS enlightenments. These embodiments introduce a compatibility component into a guest partition, which transparently operates “underneath” the guest OS within the guest partition. This compatibility component intercepts I/O operations associated with the guest OS, and processes those I/O operations using a virtualization feature that is unsupported by the guest OS, itself. In one example, the compatibility component provides accelerated hardware access by interfacing with a compatible hardware device on behalf of the guest OS. In another example, the compatibility component provides access to new hardware device types via hardware protocol translation, such as to translate between commands compatible with a first storage controller type (e.g., Integrated Drive Electronics, or IDE) used by a guest OS and commands compatible with a different second storage controller type (e.g., Small Computer System Interface, or SCSI) used by an underlying storage device. In yet another example, the compatibility component facilitates VM guest confidentiality by managing memory page confidentiality flags, by marshalling I/O payloads between confidential memory and shared memory, etc. While accelerated hardware access, hardware protocol translation, and VM guest confidentiality are provided as examples, it will be appreciated that the principles described herein can be applied to a variety of virtualization technologies, both existing and yet to be invented.

Notably, the embodiments described herein overcome the challenges outlined above. For example, using the compatibility component described herein, existing VM guests can take advantage of new hardware- and/or software-based virtualization features without needing any modifications to those VM guest's host OSs. This eliminates the need for time-consuming guest OS updates, as well as the testing, workload disruptions, and potential failures/faults that may result from those updates. Additionally, this makes new hardware- and/or software-based virtualization features available in situations that would not be otherwise possible (e.g., due to an inability to update a VM guest's guest OS due to unavailability of updates, regulatory or contractual constraints, software incompatibilities).

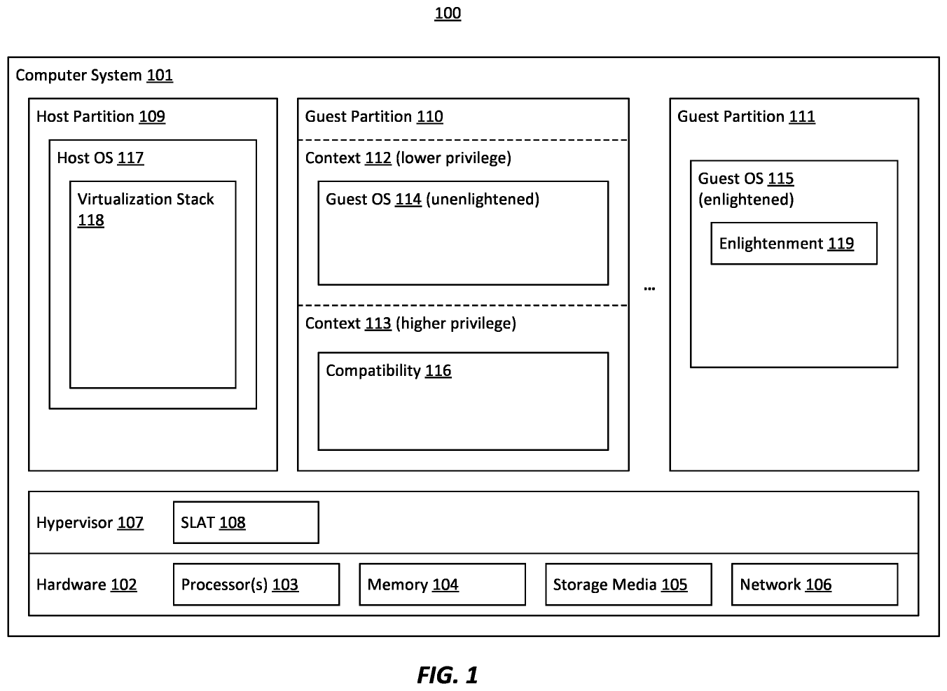

FIG. 1 illustrates an example computer architecture 100 that facilitates transparently providing virtualization features to an unenlightened guest OS. As shown, computer architecture 100 includes a computer system 101 comprising hardware 102. In FIG. 1, examples of hardware 102 includes processor(s) 103 (e.g., a processor system comprising a single processor, or a plurality of processors), memory 104 (e.g., system or main memory), a storage media 105 (e.g., a single computer-readable storage medium, or a plurality of computer-readable storage media), and a network interface 106 (e.g., one or more network interface cards) for interconnecting (via a network) to one or more other computer systems. Although not shown, hardware 102 may also include other hardware devices, such as an IOMMU, video display interface(s), user input interface(s), a trusted platform module (TPM) for facilitating a measured boot feature that provides a tamper-resistant log of loaded boot components, and the like.

As shown, in computer architecture 100, a hypervisor 107 executes directly on hardware 102. In general, the hypervisor 107 partitions hardware resources (e.g., processor(s) 103; memory 104; I/O resources such as an I/O address space, disk resources, and network resources) among a host partition 109 within which a host OS 117 executes, as well as one or more guest partitions. In computer architecture 100, hypervisor 107 is illustrated as having created a guest partition 110 within which a guest OS 114 executes, and a guest partition 111 within which a guest OS 115 executes. In FIG. 1, guest OS 114 is illustrated as being unenlightened (e.g., lacking support for a given virtualization feature), while guest OS 115 is illustrated as being enlightened (e.g., including support for that virtualization feature via enlightened client 119). In the description herein, the term “VM guest” is used to refer to a “guest partition.” In embodiments, the hypervisor 107 also enables regulated communications between partitions via a virtualized bus. As shown, the host OS 117 includes a virtualization stack 118, which manages VM guest virtualization (e.g., memory management, VM guest lifecycle management, device virtualization) via one or more application program interface (API) calls to the hypervisor 107.

In addition to isolating guest partitions from each other, some hypervisor-based virtualization technologies further operate to isolate VM guest state (e.g. registers, memory) from the host partition (and a host OS executing within), and in some cases also from the hypervisor itself. Many of these technologies can also isolate VM guest state from an entity that manages a computing system on which the VM guests are hosted. To achieve the foregoing, these virtualization technologies introduce a security boundary between at least the hypervisor 107 and the virtualization stack 118. This security boundary restricts which VM guest resources can be accessed by the host OS 117 (and, in turn, the virtualization stack 118) to ensure the integrity and confidentiality of a VM guest. Such a VM guest is referred to herein as a confidential VM (CVM) guest. Examples of hardware-based technologies that enable CVM guests include hardware-based technologies such as software guard extensions (SGX) from INTEL or secure encrypted virtualization secure nested paging (SEV-SNP) from AMD. Software-based CVM guests are also possible.

In computer architecture 100, the virtualization stack 118 is capable of dividing a guest partition into different privilege zones, referred to herein as guest privilege contexts. Thus, for example, guest partition 110 is shown as comprising guest privilege context 112 (hereinafter, context 112) and guest privilege context 113 (hereinafter, context 113). As used herein, privilege means an authority to perform security-relevant functions on a computer system. Thus, higher privilege means a greater ability to perform security-relevant functions on a computer system, and lower privilege means a lower ability to perform security-relevant functions on a computer system. In embodiments, the virtualization stack 118 can divide any of guest partitions into different guest privilege contexts. As indicated in FIG. 1, in some embodiments, context 112 is a lower privilege context (e.g., when compared to context 113), and context 113 is a higher privilege context (e.g., when compared to context 112). In these embodiments, context 112 being lower privilege than context 113 means that context 112 cannot access guest partition memory allocated to context 113. In some embodiments, context 113 can access guest partition memory allocated to context 112. In other embodiments, context 113 lacks access guest partition memory allocated to context 112.

In some embodiments, context 112 and context 113 are created based on mappings within a SLAT 108 (e.g., managed by the hypervisor 107), which comprises one or more tables that map system physical addresses (SPAS) in memory 104 to guest physical address (GPAs) seen by the guest partition 110. In these embodiments, these mappings prevent context 112 from accessing memory allocated to context 113. In one example, the hypervisor 107 is the HYPER-V hypervisor and uses virtualization-based security (VBS) to sub-partition partitions into virtual trust levels (VTLs). In this example, context 112 operates under VBS in a higher privileged VTL, and context 113 operates under VBS in a lower privileged VTL.

In other embodiments, context 112 and context 113 are created based on nested virtualization, in which the guest partition 110 operates a hypervisor that, similar to hypervisor 107, partitions resources of guest partition 110 into sub-partitions. In these embodiments, this hypervisor operating within guest partition 110 prevents context 112 from accessing memory allocated to context 113.

In FIG. 1, context 113 is shown as including a compatibility component 116. In embodiments, the compatibility component 116 intercepts I/O operations associated with the guest OS 114, and processes those I/O operations using virtualization feature(s) that are unsupported by the guest OS 114, itself (e.g., virtualization feature(s) for which the guest OS 114 lacks appropriate enlightenments). In order to process I/O operations using virtualization feature(s) for which a guest OS lacks enlightenment(s), the compatibility component 116 operates “underneath” the guest OS 114 within the guest partition. This means that the compatibility component 116 operates in a transparent manner that is independent of any direct cooperation by the guest OS 114. In some embodiments, context 113 operates as a host compatibility layer (HCL) firmware environment that provides services to the guest OS 114 running in context 112. In these embodiments, the compatibility component 116 is part of this HCL firmware environment, and provides compatibility services to the guest OS 114.

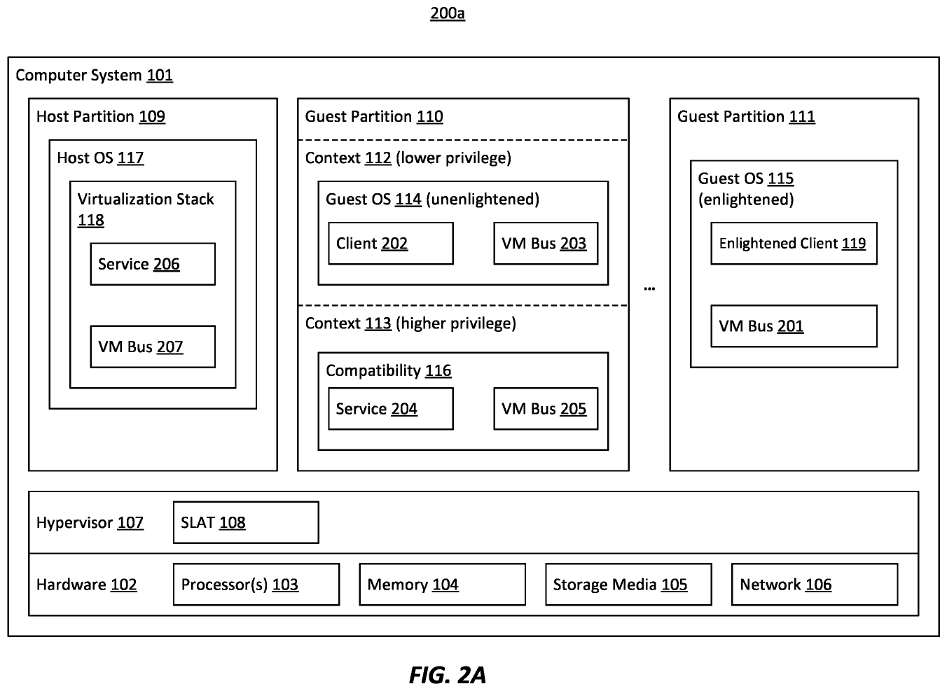

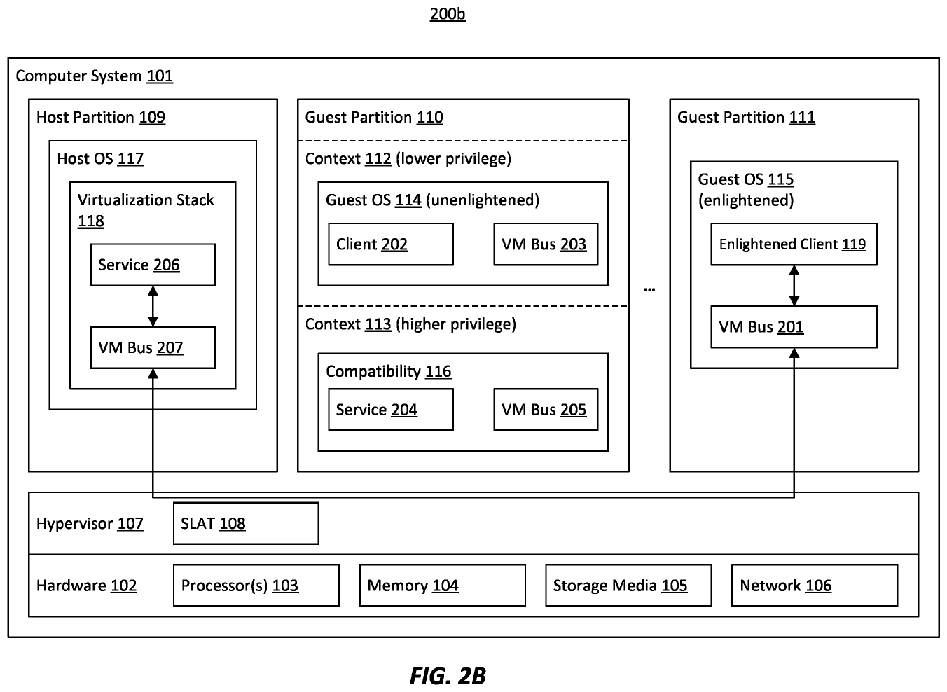

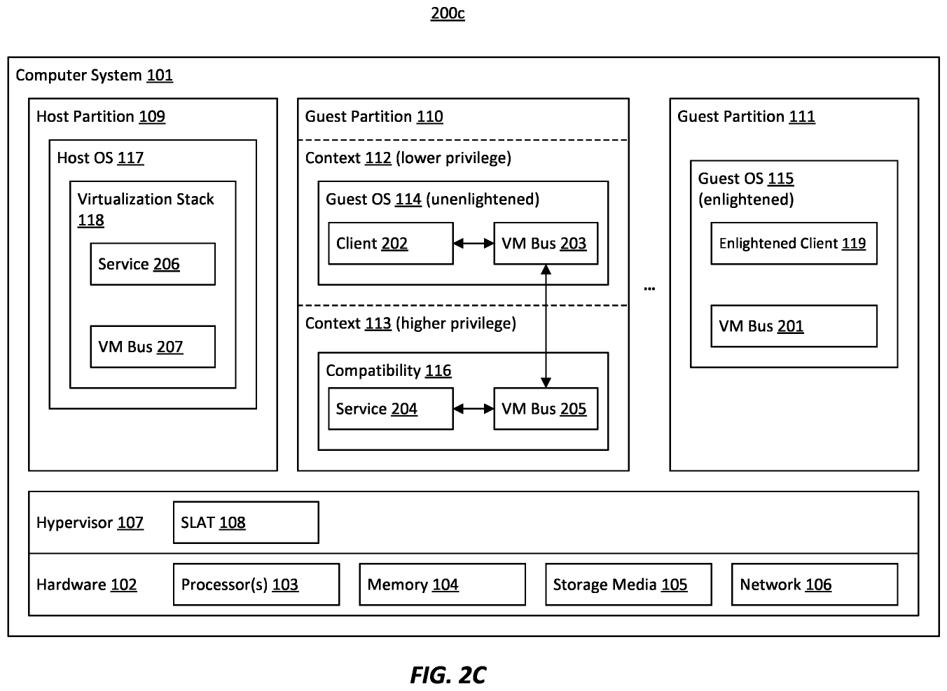

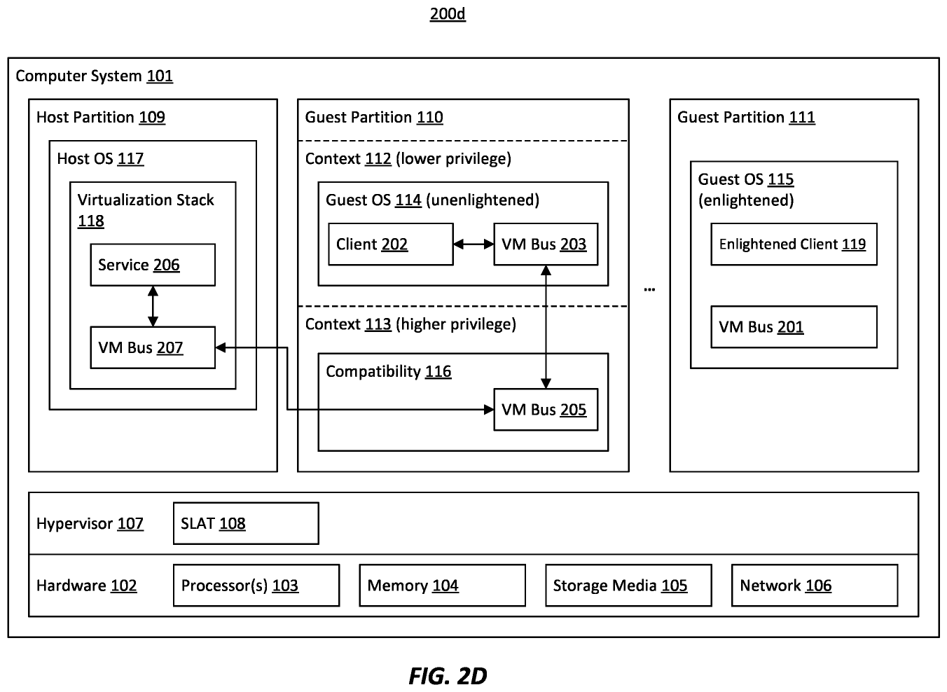

In general, the compatibility component 116 is positioned to intercept I/O operations associated with the guest OS 114. As mentioned previously, in embodiments, the hypervisor 107 enables regulated communications between partitions via a virtualized bus, which is referred to herein as virtual machine bus (VM bus). In embodiments, the compatibility component 116 intercepts I/O operations associated with the guest OS 114 via this VM bus. To demonstrate, FIG. 2A illustrates an example 200a in which computer system 101 also includes a variety of VM bus connections (or endpoints). In example 200a, these VM bus connections include a VM bus connection for guest OS 115 (VM bus 201), a VM bus connection for guest OS 114 (VM bus 203), a VM bus connection for the compatibility component 116 (VM bus 205), and a VM bus connection for host OS 117 (VM bus 207). In embodiments, a VM bus comprises a plurality of independent ring buffers (e.g., stored in memory 104), with each ring buffer corresponding to a different VM bus channel. In embodiments, two entities communicate over a VM bus channel by loading and storing values to the ring buffer corresponding to that channel, and signaling the availability of values via interrupts.

FIG. 2B illustrates an example 200b, demonstrating conventional use of a VM bus by an enlightened guest OS to utilize a virtualization feature provided by a host virtualization stack. As indicated by arrows, in example 200b, an enlightened client 119 operating within guest OS 115 communicates with a virtual service provider (service 206) operating within the virtualization stack 118 to utilize a feature (e.g., accelerated hardware access, hardware protocol translation, VM guest confidentiality) that is facilitated by the service 206. As shown, this communication is accomplished via the VM bus 201 at the guest OS 115 and the VM bus 207 at the virtualization stack 118. Here, the enlightened client 119 is specifically configured to interact with service 206 and utilize the virtualization feature, such as accelerated hardware access, that is provided by the service 206.

FIG. 2C illustrates an example 200c, demonstrating a first novel use of a VM bus, by a compatibility component, to transparently provide a virtualization feature to an unenlightened guest OS. As indicated by arrows, in example 200c a client 202 communicates via VM bus 203 as would be conventional for that client 202. However, rather than those communications being routed to VM bus 207 in the virtualization stack 118, those communications are instead consumed by the compatibility component 116 VM bus 205. Those communication are then handled, at least in part, by a virtual service provider (service 204) of the compatibility component 116. In embodiments, VM bus 205 intercepts communications targeted to VM bus 207 by being configured to use the same identity information (e.g., VM bus channel, address) as VM bus 207. In some embodiments, VM bus 205 is a VM bus server that operates at context 113, and which offers a VM Bus channel to context 112, rather than that channel being offered by VM bus 207.

Based on interception of communications sent by client 202 via VM bus 203, service 204 facilitates use of virtualization feature(s), such as accelerated hardware access, device access, or VM guest confidentiality, for which the client 202 lacks support. In some embodiments, service 204 implements an enlightenment needed to utilize a virtualization feature on behalf of the guest OS 114. For example, service 204 may implement at least a part of functionality of enlightened client 119, and interact with service 206 on behalf of client 202. In another example, service 204 may provide a virtualization feature directly, without involvement of the virtualization stack 118.

FIG. 2D illustrates another example 200d, demonstrating a second novel use of a VM bus, by a compatibility component, to transparently provide a virtualization feature to an unenlightened guest OS. In example 200d, VM bus 205 receives channels offered from VM bus 207. Then, on behalf of VM bus 207, VM bus 205 offers these channels to VM bus 203, such that client 202 (e.g., via VM bus 203) can communicate directly with service 206 (e.g., via VM bus 207). Thus, as indicated by arrows, in example 200d a client 202 communicates via VM bus 203 as would be conventional for that client 202. VM bus 205 receives those communications from VM bus 203, and proxies them to VM bus 207 where they are handled, at least in part, by service 206. In embodiments, VM bus 205 relays control plane messages (e.g., offer channel, create shared memory, delete shared memory, revoke channel) from VM bus 207 to VM bus 203. In embodiments, data plane communication (e.g., SCSI protocol packets) from service 206 (via VM bus 207) to client 202 (via VM bus 203) occur without interference by compatibility component 116 (e.g., without any translation). In some embodiments, these data plane communications are facilitated by shared memory mapped between virtualization stack 118 and guest OS 114, and by delivering interrupts directly between virtualization stack 118 and guest OS 114. In some embodiments, at creation of guest partition 110, VM bus 207 is configured to use a nonstandard port for receiving incoming control plane messages, and VM bus 205 is informed of this configuration. VM bus 205 then acts as both a client of VM bus 207 via the nonstandard port, and a server for VM bus 203 via the standard port to facilitate control plane messages.

In embodiments, the techniques of example 200d are combined with the techniques of example 200c. In an example, virtualization stack 118 exposes a SCSI controller and a non-volatile memory express (NVMe) device to guest OS 114. In this example, guest OS 114 is unequipped to use NVMe devices, but is equipped to use SCSI devices. To facilitate access to both devices, in this example the NVMe device is presented to guest OS 114 using the techniques described in connection with example 200c (e.g., with storage protocol translation by compatibility component 116), while the SCSI device is presented to guest OS 114 using the techniques described in connection with example 200d (e.g., without storage protocol translation). In some embodiments, the techniques of example 200c are used for services that are not supported by guest OS 114, while the techniques of example 200d are used for services that are supported by guest OS 114.

Regardless of how VM Bus messages are handled, in one example, a service (e.g., service 204 in the environment of example 200c, or service 206 in the environment of example 200d) facilitates use of an accelerated hardware access virtualization feature. Thus, for example, service 206 and/or service 204 may facilitate accelerated communications between client 202 and compatible hardware—such as storage media 105 or network interface 106. In these embodiments, client 202 may be a generic para-virtualized storage or network driver that lacks any awareness of, or support, for hardware acceleration. In one example, service 204 implements driver functionality for accelerated communications with such hardware (e.g., functionality present in enlightened client 119), and either communicates with that hardware directly (via hypervisor 107) or with service 206 (e.g., an accelerated hardware access service provider).

In another example, a service (e.g., service 204, service 206) facilitates use of a hardware protocol not natively supported by the guest OS 114. For example, guest OSs generally include native support IDE-based storage controllers. However, many VM hosts now commonly utilize SCSI storage controllers. Additionally, many hypervisors utilize virtualized SCSI storage controllers to present virtual (e.g., file-backed) disk images to VM guests. In either case, an unenlightened guest OS is unable to access any storage device (real or virtual) that is presented by the hypervisor 107 using a SCSI storage controller. In embodiments, a service (e.g., service 204) translates between IDE-based commands used by guest OS 114 and SCSI-based commands used by an underlying storage controller (whether that be a physical controller or a virtualized controller). This means that, to an unenlightened guest OS, a storage device appears to be IDE-based, and the unenlightened guest OS can use IDE commands to interact with that storage device. In some embodiments, service 204 receives IDE-based commands issued by guest OS 114 and intercepted by VM bus 205, translates those commands to equivalent SCSI-based commands, and forwards the translated commands to an underlying storage controller (e.g., physical controller, virtual controller). Additionally, in these embodiments, service 204 receives SCSI-based commands issued by the storage controller, translates those commands to equivalent IDE-based commands, and forwards the translated commands to guest OS 114 via VM bus 205.

In yet another example, a service (e.g., service 204, service 206) facilitates use of VM guest confidentiality virtualization features, such as through use of INTEL SGX, AMD SEV-SNP, or software-based mechanisms. Conventionally, a guest OS needed kernel enlightenments to operate within a CVM guest. Examples include memory manager enlightenments to manage confidentiality flags (e.g., C-bits) for the CVM guest's memory space, and to manage which memory pages are confidential to the CVM guest (e.g., encrypted) or shared (e.g., with the host OS). In embodiments, a service (e.g., service 204, service 206) enables a VM guest to operate as a CVM guest, even in the absence of such enlightenments to guest OS 114. In these embodiments, the service may implement memory manager enlightenments (e.g., for managing memory page confidentiality flags), exception handlers, and/or data marshalling functionality. For example, in embodiments, service 204 (and/or service 206) manages confidentiality flags to designate portion(s) the guest partition 110's memory as shared (e.g., with the host partition 109), and to designate other portion(s) the guest partition 110's memory as confidential to the guest partition 110. In embodiments, service 204 (and/or service 206) also marshals the data payloads of I/O operations originating from the client 202 from confidential memory to shared memory, and marshals the data payloads of I/O operations originating from the host OS 117 from shared memory to confidential memory.

Notably, in embodiments, the various service functions can be combined. For example, service 204 (or a plurality of services operating at compatibility component 116) may offer each of accelerated hardware access, hardware protocol translation, and VM guest confidentiality, or a subset thereof. In another example, service 206 (or a plurality of services operating at virtualization stack 118) may offer each of accelerated hardware access, hardware protocol translation, and VM guest confidentiality, or a subset thereof. In yet another example, the service functions are provided by as combination of services at compatibility component 116 and virtualization stack 118.

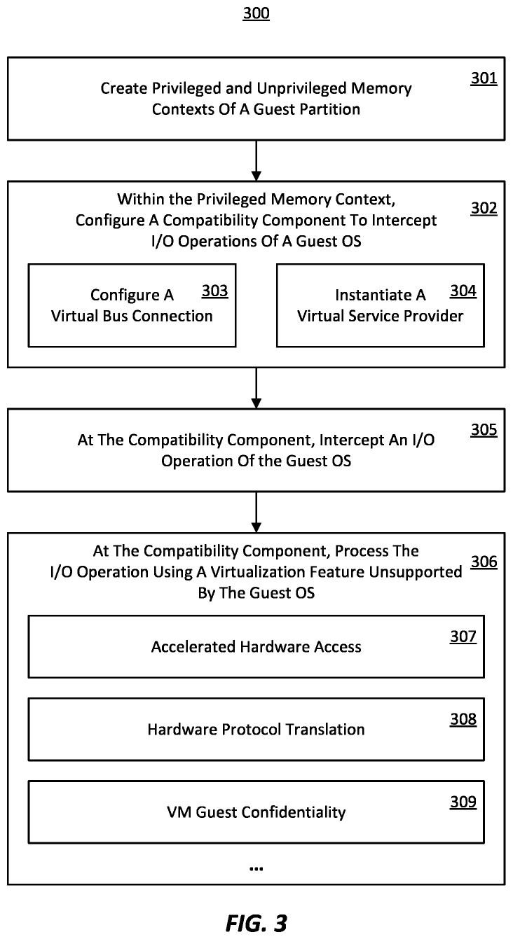

Operation of the compatibility component 116 is now described in connection with FIG. 3, which illustrates a flow chart of an example method 300 for transparently providing virtualization features to an unenlightened guest OS. In embodiments, instructions for implementing method 300 are encoded as computer-executable instructions (e.g., compatibility component 116) stored on a computer storage media (e.g., storage media 105) that are executable by a processor system (e.g., processor(s) 103) to cause a computer system (e.g., computer system 101) to perform method 300.

The following discussion now refers to a number of methods and method acts. Although the method acts may be discussed in certain orders, or may be illustrated in a flow chart as occurring in a particular order, no particular ordering is required unless specifically stated, or required because an act is dependent on another act being completed prior to the act being performed.

Referring to FIG. 3, in embodiments, method 300 comprises an act 301 of creating privileged and unprivileged memory contexts of a guest partition. In some embodiments, act 301 comprises creating a first guest privilege context and a second guest privilege context of a guest partition. In embodiments, the second guest privilege context is restricted from accessing memory associated with the first guest privilege context. In some embodiments of act 301, these contexts are created based on SLAT. In other embodiments of act 301, these contexts are created based on nested virtualization. For example, the virtualization stack 118 partitions guest partition 110 into context 112 and context 113, with context 112 being restricted from accessing memory associated with context 113. This enables the compatibility component 116 to operate within context 113 separate from the guest OS 114 (which operates context 112). In embodiments, this means that the compatibility component 116 operates in a manner that is transparent to the guest OS 114.

Method 300 also comprises an act 302 of, within the privileged memory context, configuring a compatibility component to intercept I/O operations of a guest OS. In some embodiments, act 302 comprises instantiating a compatibility component within a first guest privilege context of a guest partition. For example, in connection with booting a VM guest corresponding to guest partition 110, the compatibility component 116 is instantiated within context 113. In embodiments, the compatibility component 116 is part of an HCL that boots prior to booting guest OS 114 within context 112. This has an effect of enabling the compatibility component 116 to operate within a guest partition in a manner that is separate from a guest OS that also executes within the guest partition. In embodiments, instantiating the compatibility component includes configuring the compatibility component to intercept I/O operations associated with a guest OS that operates within a second guest privilege context of the guest partition. For example, the compatibility component 116 is configured to intercept I/O operations of the guest OS 114. This has an effect of enabling the compatibility component 116 to operate on these I/O operations in a manner that is transparent to the guest OS 114.

In some embodiments, act 302 comprises an act 303 of configuring a virtual bus connection. In embodiments, act 303 comprises configuring a first virtualized bus connection within the first guest privilege context to interface with a second virtualized bus connection within the second guest privilege context. For example, an HCL configures the VM bus 205 to intercept I/O operations sent over the VM bus 203, such as by configuring the VM bus 205 with the same VM bus channel, address, etc. used by the VM bus 207. In one embodiment, VM bus 205 is a VM bus server that offers this VM bus channel (rather than offering the VM bus channel at VM bus 207, as would be conventional). This has an effect of the VM bus 205 receiving I/O operations sent by the guest OS 114 over the VM bus 203. Additionally, in embodiments, configuring the compatibility component to intercept I/O operations associated with the guest OS in act 302 includes configuring the compatibility component to listen for I/O operations at the first virtualized bus connection. For example, the compatibility component 116 is configured to listen at VM bus 205.

In some embodiments, act 302 comprises an act 304 of instantiating a virtual service provider. In some embodiments, act 304 comprises instantiating a virtual service provider that facilitates use of a virtualization feature unsupported by the guest OS. For example, the compatibility component 116 instantiates service 204, which implements an enlightenment needed to utilize a virtualization feature (e.g., provided by the hypervisor 107 or the virtualization stack 118) on behalf of the guest OS 114. An effect is to add functionality for using a virtualization feature for which the guest OS 114 lacks an enlightenment to software that executes within the same partition as the guest OS 114, but in a manner that is transparent to guest OS 114.

Method 300 also comprises an act 305 of, at the compatibility component, intercepting an I/O operation of the guest OS. For example, compatibility component 116 intercepts an I/O operation from guest OS 114 using VM bus 205.

Method 300 also comprises an act 306 of, at the compatibility component, processing the I/O operation using a virtualization feature unsupported by the guest OS. In some embodiments, act 306 comprises, based on the compatibility component intercepting an I/O operation associated with the guest OS, the compatibility component processing the I/O operation using a virtualization feature that is unsupported by the guest OS. For example, service 204 (and/or service 206) facilitates use of a virtualization feature not supported by guest OS 114 as part of processing the I/O operation of guest OS 114 that was intercepted in act 305. An effect is to utilize a virtualization feature that is not supported by guest OS 114, in a manner that is transparent to the guest OS 114.

In some embodiments, act 306 comprises an act 307 of providing accelerated hardware access. Thus, in some embodiments, the virtualization feature is accelerated access to a hardware device. For example, service 204 (and/or service 206) facilitates accelerated hardware access, by facilitating accelerated communications between client 202 and compatible hardware. In some embodiments, service 204 (and/or service 206) implements driver functionality for accelerated communications with such hardware, and communicates with that hardware directly (via hypervisor 107). In other embodiments, service 204 communicates with service 206 (e.g., an accelerated hardware access service provider). Thus, in some embodiments, processing the I/O operation comprises processing the I/O operation with a virtual service provider for the hardware device, the virtual service provider executing within the first guest privilege context.

In some embodiments, act 306 comprises an act 308 of providing hardware protocol translation. Thus, in some embodiments, the virtualization feature is providing access to a device via hardware protocol translation. For example, service 204 (and/or service 206) performs hardware protocol translation, by receiving commands issued by guest OS 114 using a first protocol (e.g., IDE), translates those commands to equivalent commands in a second protocol (e.g., SCSI), and forwards the translated commands to an underlying physical or virtualized device (e.g., a storage controller). Additionally, service 204 (and/or service 206) receives commands in the second protocol issued by the underlying physical or virtualized device, translates those commands to equivalent commands the first protocol, and forwards the translated commands to guest OS 114 via VM bus 205.

In some embodiments, act 306 comprises an act 309 of providing VM guest confidentiality. Thus, in some embodiments, the virtualization feature is VM guest confidentiality. For example, service 204 (and/or service 206) facilitates use of VM guest confidentiality virtualization features, such as through use of INTEL SGX, AMD SEV-SNP, or software-based mechanisms. In embodiments, service 204 (and/or service 206) implements memory manager enlightenments, such as for managing memory page confidentiality flags. Thus, in some embodiments, processing the I/O operation comprises managing a page visibility flag for a memory page used to store a payload of the I/O operation. In embodiments, service 204 (and/or service 206) implements an exception handler. Thus, in some embodiments, processing the I/O operation comprises handling a hardware-triggered exception associated with the I/O operation. In some embodiments, service 204 (and/or service 206) implements data marshalling between confidential and shared memory. Thus, in some embodiments, processing the I/O operation comprises copying a payload of the I/O operation from a guest-private memory page to a host-visible memory page; or copying a payload of the I/O operation from a host-visible memory page to a guest-private memory page.

An ellipsis within act 306 indicates that the compatibility component 116 can support a variety of virtualization features beyond those demonstrated in act 307, act 308, and act 309. Thus, the compatibility component 116, and method 300, are applicable to a variety of virtualization technologies, both existing and yet to be invented.

Embodiments of the disclosure may comprise or utilize a special-purpose or general-purpose computer system (e.g., computer system 101) that includes computer hardware, such as, for example, a processor system (e.g., processor(s) 103) and system memory (e.g., memory 104), as discussed in greater detail below. Embodiments within the scope of the present disclosure also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media (e.g., storage media 105). Computer-readable media that carry computer-executable instructions and/or data structures are transmission media. Thus, by way of example, embodiments of the disclosure can comprise at least two distinctly different kinds of computer-readable media: computer storage media and transmission media.

Computer storage media are physical storage media that store computer-executable instructions and/or data structures. Physical storage media include computer hardware, such as random access memory (RAM), read-only memory (ROM), electrically erasable programmable ROM (EEPROM), solid state drives (SSDs), flash memory, phase-change memory (PCM), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., network interface 106), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

It will be appreciated that the disclosed systems and methods may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. Embodiments of the disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

It will also be appreciated that the embodiments of the disclosure may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). A cloud computing model can be composed of various characteristics, such as on-demand self-service, broad network access, resource pooling, rapid elasticity, measured service, and so forth. A cloud computing model may also come in the form of various service models such as, for example, Software as a Service (SaaS), Platform as a Service (PaaS), and Infrastructure as a Service (IaaS). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

What is claimed:

1. A method, comprising:
intercepting, by a compatibility component within a first guest privilege context of a guest partition, an input/output (I/O) operation associated with a guest operating system (OS) that operates within a second guest privilege context of the guest partition; and
processing, by the compatibility component, the I/O operation using a virtualization feature that is unsupported by the guest OS.

2. The method of claim 1, wherein the second guest privilege context is restricted from accessing memory associated with the first guest privilege context.

3. The method of claim 1, wherein the virtualization feature is accelerated access to a hardware device.

4. The method of claim 3, wherein processing the I/O operation comprises processing the I/O operation with a virtual service provider for the hardware device, the virtual service provider executing within the first guest privilege context.

5. The method of claim 1, wherein the virtualization feature is providing access to a device via hardware protocol translation.

6. The method of claim 1, wherein the virtualization feature is virtual machine guest confidentiality.

7. The method of claim 6, wherein processing the I/O operation comprises managing a page visibility flag for a memory page used to store a payload of the I/O operation.

8. The method of claim 6, wherein processing the I/O operation comprises copying a payload of the I/O operation from a guest-private memory page to a host-visible memory page.

9. The method of claim 6, wherein processing the I/O operation comprises copying a payload of the I/O operation from a host-visible memory page to a guest-private memory page.

10. The method of claim 6, wherein processing the I/O operation comprises handling a hardware-triggered exception associated with the I/O operation.

11. The method of claim 1, further comprising configuring a first virtualized bus connection within the first guest privilege context to interface with a second virtualized bus connection within the second guest privilege context.

12. The method of claim 11, further comprising configuring the compatibility component to intercept I/O operations associated with the guest OS, including configuring the compatibility component to listen for I/O operations at the first virtualized bus connection.

13. A computer system, comprising:
a processing system; and
a computer storage media that stores computer-executable instructions that are executable by the processing system to at least:
instantiate a compatibility component within a first guest privilege context of a guest partition, including configuring the compatibility component to intercept input/output (I/O) operations associated with a guest operating system (OS) that operates within a second guest privilege context of the guest partition; and
based on the compatibility component intercepting an I/O operation associated with the guest OS, the compatibility component processing the I/O operation using a virtualization feature that is unsupported by the guest OS.

14. The computer system of claim 13, wherein configuring the compatibility component to intercept I/O operations associated with the guest OS includes configuring the compatibility component to listen for I/O operations at a first virtualized bus connection, within the first guest privilege context, that interfaces with a second virtualized bus connection within the second guest privilege context.

15. The computer system of claim 13, wherein the virtualization feature is accelerated access to a hardware device, and wherein processing the I/O operation comprises processing the I/O operation with a virtual service provider for the hardware device, the virtual service provider executing within the first guest privilege context.

16. The computer system of claim 13, wherein the virtualization feature is providing access to a device via hardware protocol translation.

17. The computer system of claim 13, wherein the virtualization feature is virtual machine guest confidentiality, and wherein processing the I/O operation comprises managing a page visibility flag for a memory page used to store a payload of the I/O operation.

18. The computer system of claim 13, wherein the virtualization feature is virtual machine guest confidentiality, and wherein processing the I/O operation comprises:
copying a payload of the I/O operation from guest-private memory and host-visible memory; or
copying the payload of the I/O operation from the guest-private memory and the host-visible memory.

19. The computer system of claim 13, wherein the virtualization feature is virtual machine guest confidentiality, and wherein processing the I/O operation comprises handling a hardware-triggered exception associated with the I/O operation.

20. A computer program product comprising a computer storage media that stores computer-executable instructions that are executable by a processing system to at least:
instantiate a compatibility component within a first guest privilege context of a guest partition, including configuring the compatibility component to intercept input/output (I/O) operations associated with a guest operating system (OS) that operates within a second guest privilege context of the guest partition, wherein the second guest privilege context is restricted from accessing memory associated with the first guest privilege context; and
based on the compatibility component intercepting an I/O operation associated with the guest OS, the compatibility component processing the I/O operation using a virtualization feature that is unsupported by the guest OS.
